(19) United States
(12) Patent Application Publication
(10) Pub. No.: US 2016/0111765 A1
(43) Pub. Date: Apr. 21, 2016

(54) METALLIZED PLASTIC HIGH RADIO FREQUENCY INTEGRATED WAVEGUIDE

(71) Applicant: Hughes Network Systems, LLC, Germantown, MD (US)

(72) Inventors: Thomas Jackson, Monrovia, MD (US); Peter Hou, North Potomac, MD (US); Guo Chen, Vienna, VA (US); Barre Lankford, Sykesville, MD (US)

(73) Assignee: Hughes Network Systems, LLC, Germantown, MD (US)

(21) Appl. No.: 14/517,006

(22) Filed: Oct. 17, 2014

(51) Int. Cl. H01P 3/12

(52) U.S. Cl. CPC H01P 3/121

(57) ABSTRACT

An integrated waveguide for use in high radio frequency communication is provided. The integrated waveguide including: a first substrate including a first plastic layer having on a first inward-facing surface, a first portion of a waveguide feature formed on the first inward-facing surface, and a metal layer disposed on the first inward-facing surface; and a second substrate including a second plastic layer having a second inward-facing surface, a second portion of a waveguide feature formed on the second inward-facing surface, and a metal layer disposed on the second inward-facing surface, wherein the first substrate and the second substrate are assembled to define an integrated waveguide feature defined by an assembling of the first portion of the waveguide feature and the second portion of the waveguide feature.

### FIELD OF THE INVENTION

The disclosure relates to an integrated waveguide a metal-plated plastic assembly, in particular, an assembly assembled from multiple metal-covered plastic Injection Mold Assemblies. In particular, the assemblies may use a bonding material to fuse the assembly into an integrated assembly.

### BACKGROUND

Prior art transceivers employ either discrete waveguide devices, such as, an orthomode transducer, a filter and a diplexer, or an assembly of the same as stand-alone and separate modules. There are many inherent disadvantages with this approach, including water leakage, higher manufacturing costs, weight, signal loss and relatively large volume. These transceivers include waveguides in a microwave communications system. These waveguides have the following characteristics:
A metal housing, typically manufactured by metal die-casting, for both protection against the elements and for heat dissipation.
A combination of waveguide devices including high-pass filters, low-pass filters, band-pass filters, orthomode transducers, and diplexers. They are used either as individual devices or as a stand-alone module of assembly of these devices. These individual waveguide devices or assembly modules reside outside the transceiver housing.
These waveguide devices need to be weather sealed yet they often break leading to water ingress and the eventual failure of the entire transceiver. This is due to the inherent complex geometry of these devices that typically require split die-casting of the parts, which are then held together using adhesives or other materials to form weather tight bonds. The bonds are the weak spots subject to breakdowns.
These waveguide devices are costly to manufacture, heavy and bulky.

The disclosure of US Patent Publication No. 2011/0243562, published Oct. 6, 2011, to Jackson et al. is incorporated herein in its entirety by reference.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In exemplary embodiments, an integrated waveguide for use in radio frequency communication is provided. The integrated waveguide including: a first substrate including a first plastic layer having on a first inward-facing surface, a first portion of a waveguide feature formed on the first inward-facing surface, and a metal layer disposed on the first inward-facing surface; and a second substrate including a second plastic layer having a second inward-facing surface, a second portion of a waveguide feature formed on the second inward-facing surface, and a metal layer disposed on the second inward-facing surface, wherein the first substrate and the second substrate are assembled to define an integrated waveguide feature defined by an assembling of the first portion of the waveguide feature and the second portion of the waveguide feature.

In exemplary embodiments, a transceiver is provided. The transceiver including: a first substrate including a first plastic layer having on a first inward-facing surface, a first portion of a waveguide feature formed on the first inward-facing surface, and a metal layer disposed on the first inward-facing surface, and a second substrate including a second plastic layer having a second inward-facing surface, a second portion of a waveguide feature formed on the second inward-facing surface, and a metal layer disposed on the second inward-facing surface; and a housing wherein at least a portion of the integrated waveguide is disposed, wherein the first substrate and the second substrate are assembled to define an integrated waveguide feature defined by an assembling of the first portion of the waveguide feature and the second portion of the waveguide feature.

In exemplary embodiments, an integrated waveguide is provided. The integrated waveguide including: a first substrate including a first plastic layer having a first inward-facing surface and a first outward-facing surface, a metal layer disposed on the first inner-facing surface, and a metal layer disposed on the first outward-facing surface; and a second substrate including a second plastic layer having a second inward-facing surface and a second outward-facing surface, a metal layer disposed on the second inner-facing surface, and a metal layer disposed on the second outward-facing surface. The integrated waveguide provides that the first substrate and the second substrate are assembled to define an integrated waveguide feature defined by an assembling of the first portion of the waveguide feature and the second portion of the waveguide feature, dimensions of the first and second plastic layers are predefined, and the first and second plastic layers are dimensioned within +/−10 mils for each predefined dimension, the first plastic layer is formed using an injection mold assembly and the metal layer of the first plastic layer is disposed by copper electroplating, the first plastic layer and the second plastic layer include a plastic that minimally contracts or expands over a temperature range of −40° C. to +50° C., and the first plastic layer includes acrylonitrile-butadiene-styrene (ABS).

### DRAWINGS

In order to describe the manner in which the above-recited and other advantages and features can be obtained, a more particular description is provided below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates a cross-sectional view of an integrated waveguide according to various embodiments.

FIG. 2A illustrates a dis-assembled integrated waveguide according to various embodiments.

FIG. 2B illustrates an assembled integrated waveguide according to various embodiments.

FIG. 3 illustrates a transceiver including an integrated waveguide disposed in a housing, according to various embodiments.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

In exemplary embodiments, an integrated waveguide may be made of a different metal from that used for the transmitter housing. For example, the integrated waveguide may include copper, while the housing may include zinc or aluminum without any copper. In exemplary embodiments, the integrated waveguide may include a transmit/receive isolator, a filter and a polarizer.

In exemplary embodiments, various features of an integrated waveguide, for example, a transmit-receive isolator, a filter and a polarizer, may be first assembled (before integration) into a module by an Injection Mold Assembly (IMA) technique. The IMA technique may use molten metal as a bonding material. The IMA technique may include a split IMA assembly technique. For example, the IMA technique may use a plastic tab disposed on an outer surface of a first piece of the assembly inserted into a slot disposed in an outer surface of a second piece of the assembly. The first piece and the second piece may be bonded together by heating the assembled first piece and second piece to fuse the assembly into a single assembly or an integrated waveguide. The first piece and the second piece may be swaged together. The first piece and the second piece may be assembles using screws, glue, rivets, fasteners and the like. In exemplary embodiments, the first piece and the second piece may include abutments, walls, voids, through holes, ridges, corrugations and similar structures to define or form waveguide features thereupon, when the first piece and the second piece are assembled. For example, the first piece may include a wall that joins to a complementary wall or the like on the second feature, and the joining may define a void forming a waveguide. In exemplary embodiments, this process can be made completely automated without the use of any manual work

The integrated waveguide devices may be disposed inside a metal housing of the transceiver. Disposing the integrated waveguide devices in a housing can be advantageous. For example, this may
Greatly reduce the manufacturing cost, as the Integrated Waveguide Transmit Receive Isolation, Filters and Polarizer may be formed as part of the housing manufacturing. As such, the cost of manufacturing may be approximately halved as a portion of the waveguide may be formed as part of the housing manufacturing operation. In exemplary embodiments, the total number of parts for the entire radio may be reduce, thus, reducing the manufacturing costs.
By residing inside walls of the transceiver housing, the tendency of the waveguide devices' break down or water leakage may nearly be eliminated.
Portions of a transceiver, that are disposed in the housing, for example, the Integrated Waveguide Transmit Receive Isolation, Filters and Polarizer, need not to be weather sealed. As fewer parts of the transceiver need to be weather sealed, manufacturing cost are reduced.
By being part of the transceiver housing, the Integrated Waveguide Transmit Receive Isolation, Filters and Polarizer take less space.
For the above reason, the resulting transceiver using the Integrated Waveguide Transmit Receive Isolation, Filters and Polarizer is physically much smaller and weighs much less.

The tolerance for measurements of pieces or structures to form an integrated waveguide and any waveguide features formed thereupon, is generally specified to a tolerance of few mils (1 mil equals 1/1000 of an inch or 25.4 microns). In the prior art, it was not possible to build waveguide structures or feature thereupon to these tolerances in plastic. In exemplary embodiments, a piece or structure of the integrated waveguide including any feature thereupon is formed to a tolerance of few mils using plastic, for example, acrylonitrile-butadiene-styrene (ABS), ABS filled with glass and the like.

In exemplary embodiments, the plastic used to form the integrated waveguide may slightly contract or expand when subjected to a large ambient temperature range, for example, from about −40° C. to about 80° C., from about −50° C. to about 70° C., from about −60° C. to about 60° C. or the like. The tolerance for contraction or expansion of the plastic across the ambient temperature range may be minimal, for example, a few mils. The minimal contraction or expansion of the plastic across the ambient temperature range may be, for example, about 25 mils or less, about 10 mils or less, about 7.5 mils or less, about 5 mils or less, about 2.5 mils or less, about 1 mil or less, about 0.5 mils or less or the like.

In exemplary embodiments, one or more surfaces of the plastic to form the integrated waveguide are covered with metals. In exemplary embodiments, inward-facing surfaces of an integrated waveguide are covered with metal. In exemplary embodiments, outward-facing surfaces of the integrated waveguide are covered with metal. In exemplary embodiments, inward and outward-facing surfaces of the integrated waveguide are covered with metal.

In some embodiments, the metal covering includes foil adhered to surface with an adhesive, for example, a conductive adhesive. In some embodiments, the metal covering is formed by metal plating. In some embodiments, the metal covering is formed by vapor deposition or painting. In exemplary embodiments, a thickness of the metal covering is a few mils, for example, less than or equal to 5 mils, less than or equal to 5 mils, less than or equal to 3.5 mils, less than or equal to 2 mils, less than or equal to 1 mils, less than or equal to 0.5 mils, less than or equal to 0.25 mils, less than or equal to 0.15 mils, or the like.

The transceiver the transceiver including the integrated waveguide provides higher conductivity. The transceiver including the integrated waveguide reduces a Radio Frequency (RF) signal loss. For example, while 87% of a signal strength may be communicated using the prior art transceiver and waveguide, the efficiency of signal communication may improve to 91.2% or better with the integrated waveguide. The reduction in signal loss leads to lower cooling needs, for example, reducing the number of cooling fins needed or need for a cooling fan. The reduction in signal loss leads to better transmission and receive capabilities, over longer distances. The transceiver including the integrated waveguide reduces a power consumption requirement of the transceiver.

In exemplary embodiments, the transceiver including the integrated waveguide weighs less, for example, about two-thirds less than weight of the prior art waveguides. This may lead to a reduction in a material used to form an antenna arm and a boom arm where a transceiver may be disposed. The reduced weight may permit easier installation of an antenna and transceiver on rooftops and the like.

The integrated waveguide may be produced with reduced tooling costs, for example, one fifth the tooling costs of prior art waveguides. The integrated waveguide may be produced with reduced material costs, for example, about 50-60% of material costs of prior art waveguides.

In some embodiments, the metal covering includes metals with good electrical conductivity, for example, copper, aluminum, silver, gold or the like. In some embodiments, the metal covering includes metal alloys with good electrical conductivity.

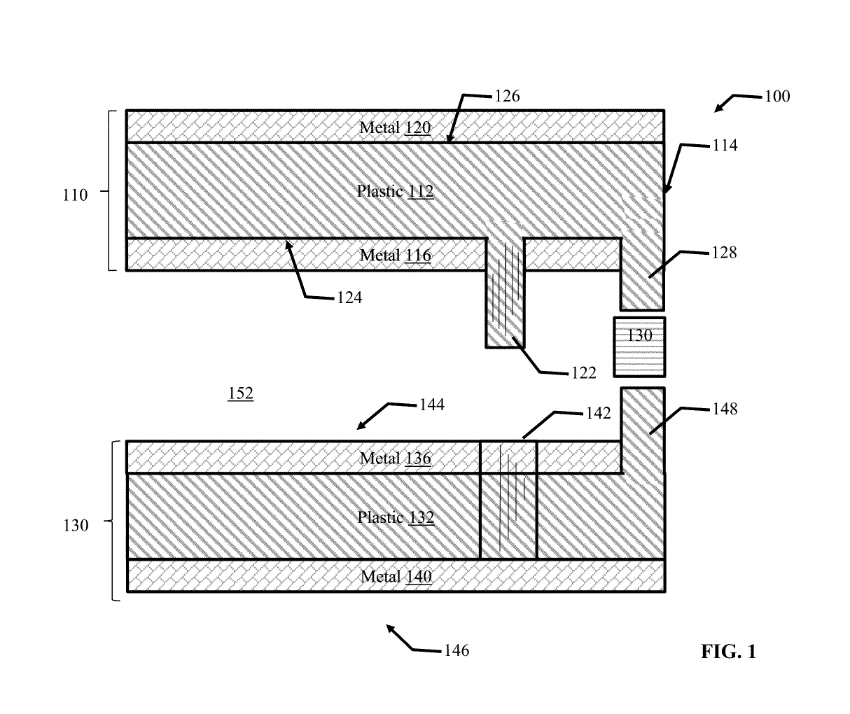

FIG. 1 illustrates a cross-sectional view of an integrated waveguide according to various embodiments.

An integrated waveguide 100 may include a first substrate 110 and a second substrate 130. The first substrate 110 may include a plastic layer 112. The plastic layer 112 may have a metal layer 116 disposed on an inward-facing surface 124. The plastic layer 112 may have a metal layer 120 disposed on an outward-facing surface 126. A portion of the plastic layer 112 may be extended to form a tab 122 to be inserted into a corresponding slot in another substrate, for example, a slot 142 in the second substrate 130. In exemplary embodiments, the tab 122 may form a feature of the integrated waveguide 100. In exemplary embodiments, the tab 122 may not extend into or be received by a slot. A portion of the plastic layer 112 may be extended to form a wall 128. The wall 128 may be affixed or sealed with a wall of another substrate, for example, a wall 148 of the second substrate 130.

The second substrate 130 may include a plastic layer 132. The plastic layer 132 may have a metal layer 136 disposed on an inward-facing surface 124. The plastic layer 112 may have a metal layer 120 disposed on an outward-facing surface 126. A portion of the plastic layer 112 may be removed to form the slot 142 that may receive a tab from another substrate, for example, tab 122 from the first substrate 120. In exemplary embodiments, the slot 142 may form a feature of the integrated waveguide 100. In exemplary embodiments, the slot 142 may not be used to receive a tab. A portion of the plastic layer 132 may be extended to form a wall 148. The wall 148 may be bonded, affixed or sealed with a wall of another substrate, for example, the wall 118 of the first substrate 110. The plastic layers 112, 132 may be assembled using a bonding layer 130 to form the integrated waveguide 100. The bonding layer 130 may include conductive glue, molten metal, an ultrasound weld, molten plastic, screws, rivets and the like. The bonding layer 130 may be disposed between the wall 118 and the wall 148. The bonding layer 130 may be disposed between the tab 122 and the slot 142. The bonding layer 130 may be disposed between the metal layer 116 and the metal layer 136.

In exemplary embodiments, all surfaces of the plastic layers 112, 132 may have a metal layer disposed thereupon, for example, the inward-facing surface 124, the outward facing surface 126, a third surface 114 and an outer surface of a waveguide feature. In exemplary embodiments, the walls 128, 148 may have a metal layer disposed thereupon. In exemplary embodiments, tab 122 may have a metal layer disposed thereupon. In exemplary embodiments, slot 142 may have a metal layer disposed thereupon. In exemplary embodiments, the plastic layers 112, 132 may include a planar surface. In exemplary embodiments, the plastic layers 112, 132 may include a non-planar surface. In exemplary embodiments, the plastic layers 112, 132 may include waveguide features, for example, a ridge, a valley, a void, an extension, a wall, an abutment, a dip, a corrugation, a saw tooth, a through hole, a via, a duct, a curved surface, an oblique surface, a fastener, a fastener receptacle or the like disposed thereupon or therein.

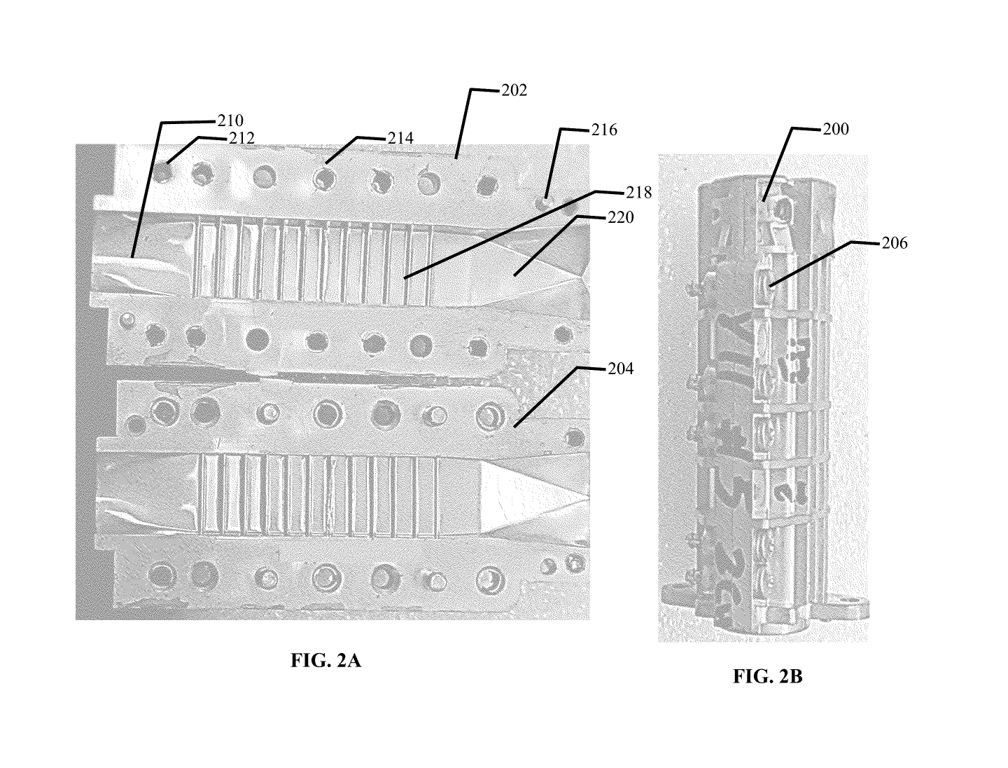

FIG. 2A illustrates a dis-assembled integrated waveguide according to various embodiments. FIG. 2B illustrates an assembled integrated waveguide according to various embodiments.

An integrated waveguide 200, for example, a polarizer may be assembled from a first substrate 202 and a second substrate 204 using a fastener 206 disposed in a fastener slot 212. The first substrate 202 may include a curved surface 210. The first substrate 202 may include a guide slot 215. The first substrate 202 may include a corrugation 218, The first substrate 202 may include a ramped or oblique surface 220

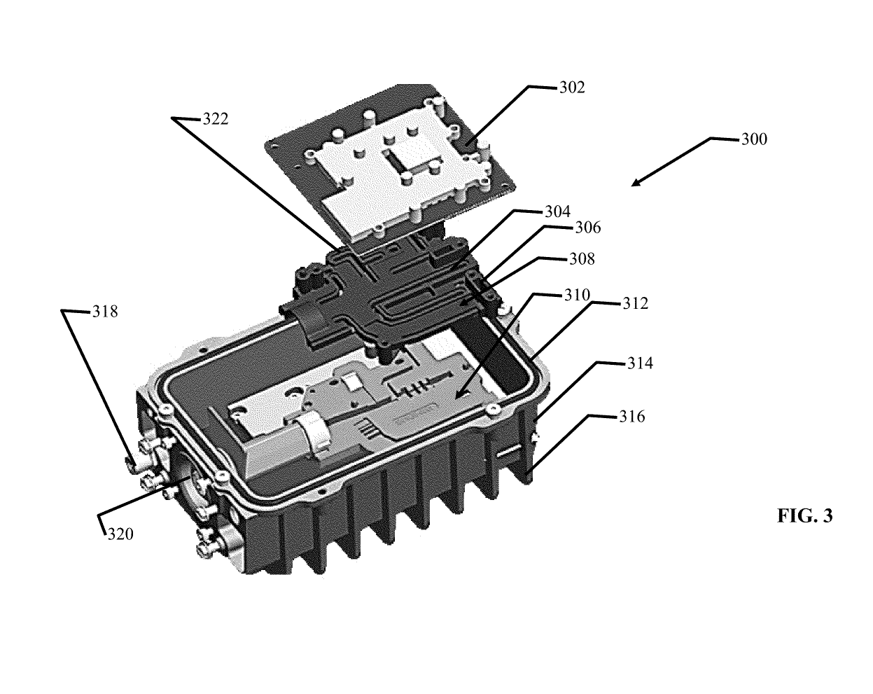

FIG. 3 illustrates a transceiver including an integrated waveguide disposed in a housing, according to various embodiments.

A transceiver 300 may include a housing 314, a circuit board 302, an integrated waveguide 304, an electrical connector 318, and a waveguide port 320. The integrated waveguide 304 may include a through hole 306, a duct (trench) 322 and the like disposed on a surface 308. In exemplary embodiments, the transceiver 300 may include a second integrated waveguide 310. The housing 314 may have a gasket 312 disposed in a groove. The gasket 312 may weather proof the housing 314 when a cover (not shown) is disposed on the housing 314. The housing 314 may include cooling fins 316.

In exemplary embodiments, the integrated waveguide may be disposed in a housing. The housing may be weather proof. The housing may include plastic walls having an inner surface. In exemplary embodiments, the wall of the housing may form a substrate that is assembled with another substrate to form an integrated waveguide. The wall of the housing may include a metal layer disposed thereupon, for example, on a portion of the inner plastic wall of the housing.

In exemplary embodiments, the integrated waveguide or the housing with the integrated waveguide may be used with outdoor units (ODU) used for satellite communications. For example, these devices may be used with HughesNet in Ku-band, HughesNet in Ka band, the Spaceway, and the upcoming Jupiter program, from Hughes Communications of Germantown, Md.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

We claim as our invention:

1. An integrated waveguide comprising:
a first substrate comprising a first plastic layer having on a first inward-facing surface, a first portion of a waveguide feature formed on the first inward-facing surface, and a metal layer disposed on the first inward-facing surface; and
a second substrate comprising a second plastic layer having a second inward-facing surface, a second portion of a waveguide feature formed on the second inward-facing surface, and a metal layer disposed on the second inward-facing surface,
wherein the first substrate and the second substrate are assembled to define an integrated waveguide feature defined by an assembling of the first portion of the waveguide feature and the second portion of the waveguide feature.

2. The integrated waveguide of claim 1, wherein the first plastic layer is formed using an injection mold assembly and the metal layer of the first plastic layer is disposed on the first inward-facing surface by electroplating.

3. The integrated waveguide of claim 1, wherein dimensions of the first and second plastic layers are predefined, and the first and second plastic layers are dimensioned within +/−10 mils for each predefined dimension.

4. The integrated waveguide of claim 1, wherein the first plastic layer and the second plastic layer comprise a plastic that minimally contracts or expands over a temperature range of −40° C. to +50° C.

5. The integrated waveguide of claim 1, wherein the first plastic layer comprises a tab extending from the first inward-facing surface, the second plastic layer comprises a slot disposed in the second inward-facing surface, and the tab is received by the slot.

6. The integrated waveguide of claim 1, wherein the first plastic layer comprises acrylonitrile-butadiene-styrene (ABS) and the metal layer of the first plastic layer comprises copper.

7. The integrated waveguide of claim 1, further comprising a void formed by the assembly of the first substrate and the second substrate, wherein the void forms a portion of the integrated waveguide feature.

8. The integrated waveguide of claim 1, further comprising an ultrasound weld to assemble the first substrate and the second substrate.

9. The integrated waveguide of claim 1, wherein the metal layer has an average minimum depth between 2 microns and 500 microns.

10. The integrated waveguide of claim 1, wherein the integrated waveguide comprises one or more of a high Radio Frequency (RF) filter, high-pass filter, low-pass filter, band-pass filter, orthomode transducer and diplexer.

11. A transceiver comprising:
an integrated waveguide comprising:
a first substrate comprising a first plastic layer having on a first inward-facing surface, a first portion of a waveguide feature formed on the first inward-facing surface, and a metal layer disposed on the first inward-facing surface, and
a second substrate comprising a second plastic layer having a second inward-facing surface, a second portion of a waveguide feature formed on the second inward-facing surface, and a metal layer disposed on the second inward-facing surface; and
a housing wherein at least a portion of the integrated waveguide is disposed,
wherein the first substrate and the second substrate are assembled to define an integrated waveguide feature defined by an assembling of the first portion of the waveguide feature and the second portion of the waveguide feature.

12. The transceiver of claim 11, wherein the first plastic layer is formed using an injection mold assembly and the metal layer of the first plastic layer is disposed on the first inward-facing surface by electroplating.

13. The transceiver of claim 11, wherein dimensions of the first and second plastic layers are predefined, and the first and second plastic layers are dimensioned within +/−10 mils for each predefined dimension

14. The transceiver of claim 11, wherein the first plastic layer and the second plastic layer comprise a plastic that minimally contracts or expands over a temperature range of −40° C. to +50° C.

15. The transceiver of claim 11, wherein the first plastic layer comprises a tab extending from the first inward-facing surface, the second plastic layer comprises a slot disposed in the second inward-facing surface, and the tab is received by the slot.

16. The transceiver of claim 11, wherein the first plastic layer comprises acrylonitrile-butadiene-styrene (ABS) and the metal layer of the first plastic layer comprises copper.

17. The transceiver of claim 11, further comprising a void formed by the assembly of the first substrate and the second substrate, wherein the void forms a portion of the integrated waveguide.

18. The transceiver of claim 11, further comprising an ultrasound weld to assemble the first substrate and the second substrate.

19. The transceiver of claim 11, wherein the metal layer has an average minimum depth between 2 microns and 500 microns.

20. An integrated waveguide comprising:
a first substrate comprising
a first plastic layer having a first inward-facing surface and a first outward-facing surface,
a metal layer disposed on the first inner-facing surface, and
a metal layer disposed on the first outward-facing surface; and
a second substrate comprising
a second plastic layer having a second inward-facing surface and a second outward-facing surface,
a metal layer disposed on the second inner-facing surface, and
a metal layer disposed on the second outward-facing surface,
wherein
the first substrate and the second substrate are assembled to define an integrated waveguide feature defined by an assembling of the first portion of the waveguide feature and the second portion of the waveguide feature,
dimensions of the first and second plastic layers are predefined, and the first and second plastic layers are dimensioned within +/−10 mils for each predefined dimension,
the first plastic layer is formed using an injection mold assembly and the metal layer of the first plastic layer is disposed by copper electroplating, and
the first plastic layer and the second plastic layer comprise an acrylonitrile-butadiene-styrene (ABS) plastic that minimally contracts or expands over a temperature range of −40° C. to +50° C.

21. The integrated waveguide of claim 20, further comprising a void formed by the assembly of the first substrate and the second substrate, wherein the void forms a portion of the integrated waveguide feature.

22. The integrated waveguide of claim 20, further comprising an ultrasound weld to assemble the first substrate and the second substrate.
